(19) United States
(12) Patent Application Publication
(10) Pub. No.: US 2006/0182905 A1
(43) Pub. Date: Aug. 17, 2006

(54) Ink jet sheet

(76) Inventors: Naoyuki Ishii, Shizuoka (JP); Hirotaka Yamamoto, Shizuoka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/297,297

(22) Filed: Dec. 9, 2005

(30) Foreign Application Priority Data
Feb. 17, 2005 (JP) 2005-041006

(51) Int. Cl. B41M 5/00

(52) U.S. Cl. 428/32.29

(57) ABSTRACT

The present invention provides an ink jet sheet which has biodegradability and prevents blurring of recorded images as well as ensures excellent image qualities which have been essentially required for conventional ink jet sheets. The ink jet sheet has a support and an ink receiving layer provided on at least one surface of the support, wherein the support has biodegradability, and the ink receiving layer contains poly(diallydimethylammonium chloride) (A), a dimethylamine-epichlorohydrin polymer (B), and, as a binder, a biodegradable resin (C).

### BACKGROUND OF THE INVENTION

1. Field of the Invention

The present invention relates to an ink jet sheet and more particularly, to an ink jet sheet which ensures excellent image quality, has biodegradability, and prevents blurring of recorded images.

2. Background Art

Among a variety of image formation techniques, ink jet recording has advantages such as readiness in provision of high-quality full color images and high-speed printing, and low running cost. Therefore, ink jet printing has been employed in a wide range of applications such as printers for computers and color copying machines, and such ink-jet type apparatuses have rapidly increased. Under such circumstances, ink jet sheets must satisfy requirements in image quality such as an appropriate image density, absence of blurring, and surface toughness.

Meanwhile, as word processors and computers have been employed more and more, the amount of information recording sheet waste has problematically increased. In recent years, the most problematic in the environment has been plastic products, which are not decomposable even over a long period of time, making the waste treatment thereof considerably difficult. Particularly, since ink jet recording media for providing high-quality images are generally made of a plastic or paper support coated with a plastic material, landfill-disposed wastes thereof are stable for a long period of time, similar to the case of plastic products. Thus, such stability is problematic.

Recording sheets for solving the above problem have been proposed. For example, Japanese Patent Application Laid-Open (kokai) No. 11-198522 discloses a recording sheet made of a paper support coated with an aliphatic polyester. The support is highly biodegradable and is advanced in terms of minimizing impact to the environment. However, the recording sheets provide poor image quality, in particular, problematic blurring of images.

### SUMMARY OF THE INVENTION

Under such circumstances, an object of the present invention is to provide an ink jet sheet which ensures image qualities that have essentially been required for conventional ink jet sheets, and which has biodegradability and prevents blurring of recorded images.

The present inventors have carried out extensive studies in order to attain the aforementioned object, and have found that an ink jet sheet which has biodegradability and prevents blurring of recorded images can be produced through employment of an ink receiving layer into which poly(diallydimethylammonium chloride), a dimethylamine-epichlorohydrin polymer, and a binder containing a biodegradable resin have been incorporated. Conventionally, incorporation of a cationic substance into an ink receiving layer is known to be a possible countermeasure against image blurring. However, this technique cannot completely solve the problem when a general cationic substance is used. The present inventors have found that image blurring can be remarkably prevented by incorporation, into an ink receiving layer, of poly(diallydimethylammonium chloride) and a dimethylamine-epichlorohydrin polymer in combination. The present invention has been accomplished on the basis of this finding.

Accordingly, the present invention provides

(1). An ink jet sheet comprising a support and an ink receiving layer provided on at least one surface of the support, wherein the support has biodegradability, and the ink receiving layer contains poly(diallydimethylammonium chloride) (A), a dimethylamine-epichlorohydrin polymer (B), and, as a binder, a biodegradable resin (C).

(2). An ink jet sheet as described in (1), wherein the biodegradable resin (C) is a biodegradable polyester.

(3). An ink jet sheet as described in (2), wherein the biodegradable polyester is an aliphatic polyester.

(4). An ink jet sheet as described in any one of (1) to (3), wherein the ink receiving layer contains poly(diallydimethylammonium chloride) (A) in an amount of 2 to 10 mass % as solid content and a dimethylamine-epichlorohydrin polymer (B) in an amount of 0.5 to 7 mass % as solid content.

(5). An ink jet sheet as described in any one of (1) to (4), wherein the binder included in the ink receiving layer contains a biodegradable resin (C) in an amount of 50 mass % or more.

### DETAILED DESCRIPTION OF PREFERRED EMBODIMENTS

The ink jet sheet of the present invention is formed of a support, and an ink receiving layer provided on at least one surface of the support, wherein the support has biodegradability.

No particular limitation is imposed on the support of the ink jet sheet of the present invention, so long as the support has biodegradability. The support may be formed of biodegradable plastic film, paper, fabric, non-woven fabric, etc.

As used herein, the term “biodegradability” refers to an ability to be decomposed by microorganisms present in the natural world.

No particular limitation is imposed on the biodegradable plastic material forming the biodegradable plastic film employed as the support of the present invention, so long as the plastic material has the aforementioned properties and a level of durability that ensures practical use in practice in the atmosphere. Examples of plastic materials preferably employed include poly(lactic acid), a starch and modified poly(vinyl alcohol) mixture, a poly(butylene succinate/adipate) copolymer, polycaprolactone, and a poly(hydroxybutylate/valerate) copolymer. Of these, poly(lactic acid) is particularly preferred, from the standpoint of degradation rate and film strength. In accordance with needs, other plastic materials may be added to enhance properties such as film strength, without impairing biodegradability.

No particular limitation is imposed on the paper employed as the support, so long as the paper has biodegradability, and natural pulp-based paper may be employed. Examples of the paper which may be employed in the invention include wood free paper, mechanical paper, wood pulp paper, kraft paper, art paper, coat paper, and cast coated paper.

No particular limitation is imposed on the fabric and non-woven fabric employed as the support, so long as it has biodegradability, and natural fiber-based fabric (e.g., cotton-based fabric) may be employed. Among non-woven fabric species, a non-woven fabric formed without use of a binder is particularly preferred, by virtue of high biodegradability. Examples of such non-woven fabrics include Oikos AP21201500 (product of Nisshinbo Industries, Inc.).

The support may have a single-layer structure or a multilayer structure. The multilayer structure may be formed through any of known methods, for example, laminating layers by the mediation of adhesive; co-extrusion in which different materials are extruded by means of a plurality of extruders, thereby forming a laminate film; and extrusion-lamination in which one film is extruded through an extruder, directly onto another film, thereby forming a laminate film.

In accordance with needs, the surface of the support on which an ink receiving layer is provided may be treated so as to enhance adhesion and wetting with respect to the ink receiving layer or other layers. Examples of the surface treatment include oxidation (e.g., corona discharge treatment or hot air blow treatment) and roughening (e.g., sand blast or solvent treatment). The surface treatment is appropriately selected in accordance with the type of the support. Generally, corona discharge treatment is preferably employed, from the viewpoint of effect and operability. Alternatively, an anchor coat layer may be provided so that the layer is in contact with the support and the ink receiving layer (i.e., adhesion facilitating treatment).

The ink receiving layer of the ink jet sheet of the present invention is formed of a filler, a binder, and other additives.

No particular limitation is imposed on the type of the filler, and both inorganic and organic fillers may be used. Examples of the filler include silica, calcium carbonate, talc, clay, diatomaceous earth, polystyrene, polymethacrylates, titanium oxide, burned kaolin, and hydrous magnesium silicate. These fillers may be used singly or in combination.

Particularly, silica is preferably employed as a filler, since image quality and ink absorption are enhanced. When employed as a filler, silica preferably exhibits peaks, in a pore volume distribution curve, within a range of 0.8 to 1.3 mL/g and within a range of 1.5 to 1.9 mL/g. In order to attain the above peak characteristics, a commercial silica product exhibiting a pore volume peak within 0.8 to 1.3 mL/g and that exhibiting a pore volume peak within 1.5 to 1.9 mL/g may be used in combination. Through employment of silica having such peak characteristics, both ink absorbability and strength of the ink receiving layer can be satisfied.

The ink receiving layer preferably has a filler content (as solid) of 45 to 70 mass %, more preferably 50 to 65 mass %. When the filler content is 70 mass % or less, strength of the ink receiving layer increases, and when the filler content is 45 mass % or more, excellent ink absorbability is attained.

In the present invention, the binder contained in the ink receiving layer may contain a biodegradable resin (C).

No particular limitation is imposed on the biodegradable resin (C). Examples of the biodegradable resin (C) include microorganism-produced biodegradable materials such as poly(hydroxybutylate) and a hydroxybutylate-valerate copolymer; chemically synthesized biodegradable materials such as a poly(butylene succinate)/carbonate mixture, poly(lactic acid), a lactic acid-derived co-polyester, polycaprolactone, poly(butylene adipate), poly(vinyl alcohol), and an aliphatic polyester; and natural polymer-based biodegradable materials such as cellulose acetate, starch, chitosan, and cellulose. These biodegradable resins may be used singly or in combination. Of these, biodegradable polyesters such as poly(lactic acid) and lactic acid-derived co-polyester are preferred, because of their low cost. Aliphatic polyesters are particularly preferred, since high-quality images can be obtained.

Use of a biodegradable polyester and poly(vinyl alcohol) in combination is preferred, since image quality, biodegradability, and strength of the ink receiving layer can be readily maintained at high levels.

The binder may be formed of only a biodegradable resin. Alternatively, other binders may be added in accordance with needs, so long as the effect of the present invention is not impaired. Examples of employable binders include poly(vinyl butyral), gelatin, poly(vinyl acetal), carboxymethyl cellulose, polyvinylpyrrolidone, polyester, acrylic resin, polyurethane, chlorinated polypropylene, poly(vinyl versatate), copolymers thereof, styrene-acrylic copolymers, ethylene-vinyl acetate copolymer, and styrene-butadiene rubber.

The total amount of employed other binders is preferably controlled such that the amount of biodegradable resin (as solid content) in all binder resins is 50 mass % or more, more preferably 90 mass % or more.

The binder content of the ink receiving layer is preferably 15 to 40 mass % as solid content in the ink receiving layer, more preferably 20 to 35 mass %. When the binder content is 40 mass % or less, excellent ink absorbability can be attained, and when the binder content is 15 mass % or more, strength of the ink receiving layer increases.

According to the present invention, the ink receiving layer contains, as additives, poly(diallydimethylammonium chloride) (A) and a dimethylamine-epichlorohydrin polymer (B), which are cationic substances.

Preferably, the ink receiving layer contains poly(diallydimethylammonium chloride) (A) in an amount of 2 to 10 mass % as solid content and a dimethylamine-epichlorohydrin polymer (B) in an amount of 0.5 to 7 mass % as solid content. More preferably, the poly(diallydimethylammonium chloride) (A) content is 4 to 8 mass % and the dimethylamine-epichlorohydrin polymer (B) content is 2 to 5 mass %. Through controlling of the (A) content and (B) content so as to fall within the above ranges, well balanced performance in terms of image density and blurring prevention can be attained, leading to provision of remarkably high-quality image.

Since poly(diallydimethylammonium chloride) (A) and a dimethylamine-epichlorohydrin polymer (B), which are cationic substances, are incorporated into the ink receiving layer, thereby attaining excellent image quality, an additional cationic substance is not needed. However, an additional cationic substance may also be added to the ink receiving layer in accordance with needs. No particular limitation is imposed on the additional cationic substance, and there may be employed any of known cationic substances including dicyan compounds such as dicyandiamide-formalin condensate, polyamine compounds such as polyethylene-polyamine, and polycationic compounds such as polyallylamine salts.

The ink receiving layer preferably contains a water-soluble aluminum salt. Through incorporation of the aluminum salt, waterproofing performance, coloring performance, and blurring prevention performance can be enhanced. Examples of employable water-soluble aluminum salts include basic aluminum lactate and aluminum sulfate.

No particular limitation is imposed on the amount (solid content) of the water-soluble aluminum salt in the ink receiving layer, and the solid content is preferably 1 to 5 mass %. When the solid content of the water-soluble aluminum salt falls within this range, the aforementioned effects can be further enhanced, and rubbing resistance of the ink receiving layer in its wet state is also enhanced.

In addition to the water-soluble aluminum salt, the ink receiving layer preferably contains hydrated aluminum oxide. Through incorporation of hydrated aluminum oxide, waterproofing performance, blurring prevention performance, and coloring performance of the ink receiving layer can be enhanced.

No particular limitation is imposed on the amount (solid content) of the hydrated aluminum oxide in the ink receiving layer, and the solid content is preferably 0.5 to 8 mass %. When the solid content of the hydrated aluminum oxide falls within this range, the aforementioned effects can be further enhanced, and rubbing resistance of the ink receiving layer in its wet state is also enhanced.

In addition to the aforementioned additives (i.e., cationic substances, water-soluble aluminum salts, and hydrated aluminum oxide), other additives such as a defoaming agent, an antistatic agent, a UV-absorber, a fluorescence brightener, a preservative, a pigment dispersant, and a thickener may be incorporated into the ink receiving layer in accordance with needs, without deviating from the scope of the present invention. These additives may be incorporated into a coating solution for forming the ink receiving layer.

When in the dry state, the ink receiving layer preferably has a thickness of 35 to 50 μm. When the thickness is 50 μm or less, excellent strength of the ink receiving layer is obtained, and when the thickness is 35 μm or more, excellent ink absorbability is obtained.

As mentioned above, the ink jet sheet of the present invention has at least one ink receiving layer which contains poly(diallydimethylammonium chloride) (A), a dimethylamine-epichlorohydrin polymer (B), and, as a binder, a biodegradable resin (C) (hereinafter, the layer may be referred to as the ink receiving layer of the present invention), the layer being provided on at least one surface of a support. The ink receiving layer employed in the present invention may be provided on one surface of the support or two surfaces of the support. Two or more ink receiving layers may be provided on one surface of the support. Specifically, when two ink receiving layers of the present invention are stacked on one surface of the support so that the total thickness thereof is the same as the thickness of a single ink receiving layer, cracking of ink receiving layer is more effectively prevented as compared with the case where a single ink receiving layer is employed.

In the present invention, an additional ink receiving layer may be also provided. For example, an ink receiving layer which does not impair the effect of the ink receiving layer of the present invention may also be provided. In one embodiment, an ink receiving layer containing a titanium oxide filler is provided between the support and the ink receiving layer of the present invention, whereby the ink jet sheet exhibits enhanced covering performance. Alternatively, an additional ink receiving layer may be provided on the surface opposite the surface on which the ink receiving layer of the present invention has been provided.

The ink jet sheet of the present invention may have an additional layer other than an ink receiving layer. For example, an anchor coat layer may be provided between the ink receiving layer and the support in order to enhance interlayer adhesion. In order to enhance covering performance, a layer having low transparency may be provided. Furthermore, a UV-absorbing layer or an anti-curling layer may also be provided.

The ink receiving layer and other layer such as the anchor coat layer may be formed by dispersing or dissolving essential components in a solvent to form a coating liquid, applying the coating liquid, and drying. The coating step may be performed through any of various known techniques such as reverse roll coating, air knife coating, gravure coating, blade coating, comma coating, and wire bar coating.

No particular limitation is imposed on the ink for providing an image on the ink jet sheet of the present invention. However, a water thinnable ink is preferred. According to the present invention, in a case where a water thinnable pigment ink is used and a case where a water thinnable dye ink is used, remarkably high quality images can be obtained.

### EXAMPLES

The present invention will next be described in detail by way of examples, which should not be construed as limiting the invention thereto.

Upon performance evaluation in the following Example 1 and Comparative Example 1, image printing was performed by use of a dye-type ink jet printer (BJ F9000, product of Canon Inc.) and a pigment-type ink jet printer (DJ5000CP, product of Hewlett-Packard Company). In both cases, genuine inks for the respective printers were used.

The performance of the ink jet recoding sheets was evaluated through the following procedure.

(1) Blurring

Images of cyan, magenta, yellow, black, light cyan, and light magenta, respectively, were printed with an image quality of ISO high-fine color digital standard image N3A.

The ink jet printer (BJ F9000) and the ink jet printer (DJ5000CP) were operated in “high-quality mode” and “Yupo synthetic paper mode,” respectively.

The obtained images were visually observed in terms of blurring and evaluated on the basis of the following ratings.

◯: no blurring, desired image

X: blurring, undesired image

(2) Image Density

Solid images of four inks: (a) cyan, (b) magenta, (c) yellow, and (d) black (i.e., cyan-magenta-yellow mixture), respectively, were printed. Reflection density of each image was determined by means of a Macbeth optical densitometer (RD-918). The operation mode of each printer was the same as employed in evaluation of blurring.

(3) Rubbing Resistance of Ink Receiving Layer in a Wet State (Friction in Wet State)

The surface of an ink jet sheet was rubbed with a sufficiently wetted swab in a reciprocating motion at a load of 100 g until the ink receiving layer was exfoliated. The number of reciprocal motion cycles (to and fro make one reciprocal motion, one-way path being about 50 mm) until exfoliation was counted. The number of reciprocal motions until the ink receiving layer was removed from the support was counted. Rubbing resistance was evaluated on the basis of the following ratings.

◯: ≧20 reciprocal motions

X: <20 reciprocal motions

### Example 1

An ink jet sheet was produced through the following procedure. Specifically, a poly(lactic acid) film having a thickness of 250 μm (LACEA film, biodegradable, product of Mitsui Chemicals, Inc.) was used as a support. To one surface of the support, the following coating liquid (A) for forming an anchor coat layer was applied so as to adjust a layer thickness after drying to 5 μm. The applied liquid was dried to form an anchor coat layer. To the thus-formed anchor coat layer, the following coating liquid (B) for forming an ink receiving layer was applied so as to adjust a layer thickness after drying to 45 μm. The applied liquid was dried to form an ink receiving layer.

Performance of the thus-obtained ink jet sheet was evaluated, and the results are shown in Table 1.

In the column “Employed printer” in Table 1, “BJ” denotes a dye-type ink jet printer (BJ F9000, product of Canon Inc.) and “DJ” denotes a pigment-type ink jet printer (DJ5000CP, product of Hewlett Packard).

(A) Coating liquid for forming an anchor coat layer, which is a uniform mixture liquid containing the following ingredients:

Acrylic resin (Acronal YJ-6221D, solid content 49 mass %, anionic, product of BASF Dispersions Co., Ltd.) (60.00 parts by mass)

Calcium carbonate (Cal-light SA, solid content 100 mass %, aragonite-based, product of Shiraishi Central Laboratories Co., Ltd.) (10.00 parts by mass)

Water (30.00 parts by mass)

(B) Coating liquid for forming an ink receiving layer, which is a uniform liquid containing the following ingredients:

(a) Fillers

Silica (Mizukasil P-50, solid content 100 mass %, pore volume 1.1 mL/g, product of Mizusawa Industrial Chemicals Ltd.) (16.75 parts by mass)

Silica (Mizukasil P-78D, solid content 100 mass %, pore volume 1.7 mL/g, product of Mizusawa Industrial Chemicals Ltd.) 16.75 parts by mass)

(b) Binders

Aliphatic polyester (Bionolle Emulsion EM-530, solid content 53.8 mass %, biodegradable, product of Showa Highpolymer Co., Ltd.) (12.19 parts by mass)

Silanol-modified poly(vinyl alcohol) (Kuraray R Polymer R-1130, solid content 100 mass %, biodegradable, product of Kuraray Co., Ltd.) (9.84 parts by mass)

(c) Additives

Poly(diallyldimethylammonium chloride) (Papyogen P-113, solid content 42 mass %, product of Senka) (8.12 parts by mass)

Dimethylamine-epichlorohydrin polymer (Neofix RE, solid content 40 mass %, product of Nicca Chemical Co., Ltd.) (3.67 parts by mass)

Basic aluminum lactate (Takiceram M-160L, solid content 25 mass %, product of Taki Chemical Co., Ltd.) (7.98 parts by mass)

Hydrated aluminum oxide (Aluminasol 200, solid content 10 mass %, product of Nissan Chemical Industries, Ltd.) (5.20 parts by mass)

Surfactant (Olfine PD-001, solid content 85 mass %, product of Nisshin Chemical Industry Co., Ltd.) (0.63 parts by mass)

Fluorescent brightener (Blankophor UW liquid, solid content 100 mass %, product of Bayer A. G.) (0.38 parts by mass)

Defoaming agent (SN-Defoamer 480, solid content 100 mass %, product of San Nopco Ltd.) (0.04 parts by mass)

(d) Water (154.16 Parts by Mass)

### Comparative Example 1

The procedure of Example 1 was repeated, except that the amount of poly(diallyldimethylammonium chloride) (Papyogen P-113) was increased by 3.50 parts to 11.62 parts by weight, and dimethylamine-epichlorohydrin polymer (Neofix RE) was not used, to thereby produce a coating liquid for forming an ink receiving layer and produce an ink jet sheet therefrom.

The thus-produced ink jet sheet was evaluated, and the results are shown in Table 1.

TABLE 1

| | |
|---|---|
| Example 1 | Comp. Ex. 1 |

| Employed printer | BJ | DJ | BJ | DJ |
|---|---|---|---|---|
| (Evaluation) | | | | |
| (1) Blurring | ◯ | ◯ | ◯ | X |
| (2) Image density | | | | |
| Cyan | 1.45 | 1.39 | 1.48 | 1.30 |
| Magenta | 1.55 | 1.41 | 1.58 | 1.38 |
| Yellow | 1.60 | 1.42 | 1.60 | 1.44 |
| Black (mix) | 1.48 | 1.50 | 1.48 | 1.46 |

| | | |
|---|---|---|
| (3) Wet-state friction | ◯ | ◯ |

According to the present invention, a biodegradable support and an ink receiving layer containing a biodegradable resin serving as a binder, which is a comparatively predominant component of the ink receiving layer, are employed. Therefore, the ink jet sheet of the present invention exhibits high biodegradability. In the case where the ink jet sheet of the present invention is buried in the soil as waste, the sheet can be readily decomposed. Thus, the recoding sheet imposes less load to the environment.

In addition, through incorporation, into the ink receiving layer, of poly(diallydimethylammonium chloride) (A) and a dimethylamine-epichlorohydrin polymer (B), blurring of the recorded images can be prevented with remarkable effectiveness. In a case where a water thinnable dye ink is used and a case where a water thinnable pigment ink is used, blurring of the image can be prevented.

The ink jet sheet of the present invention provides excellent essential qualities required for ink jet printing such as image density, color reproduction, and rubbing resistance of the ink receiving layer in a wet state.

1. An ink jet sheet comprising a support and an ink receiving layer provided on at least one surface of the support, wherein the support has biodegradability, and the ink receiving layer contains poly(diallydimethylammonium chloride) (A), a dimethylamine-epichlorohydrin polymer (B), and, as a binder, a biodegradable resin (C).

2. An ink jet sheet as described in claim 1, wherein the biodegradable resin (C) is a biodegradable polyester.

3. An ink jet sheet as described in claim 2, wherein the biodegradable polyester is an aliphatic polyester.

4. An ink jet sheet as described in claim 1, wherein the ink receiving layer contains poly(diallydimethylammonium chloride) (A) in an amount of 2 to 10 mass % as solid content and a dimethylamine-epichlorohydrin polymer (B) in an amount of 0.5 to 7 mass % as solid content.

5. An ink jet sheet as described in claim 1, wherein the binder included in the ink receiving layer contains a biodegradable resin (C) in an amount of 50 mass % or more.

6. An ink jet sheet as described in claim 2, wherein the ink receiving layer contains poly(diallydimethylammonium chloride) (A) in an amount of 2 to 10 mass % as solid content and a dimethylamine-epichlorohydrin polymer (B) in an amount of 0.5 to 7 mass % as solid content.

7. An ink jet sheet as described in claim 6, wherein the binder included in the ink receiving layer contains a biodegradable resin (C) in an amount of 50 mass % or more.

8. An ink jet sheet as described in claim 3, wherein the ink receiving layer contains poly(diallydimethylammonium chloride) (A) in an amount of 2 to 10 mass % as solid content and a dimethylamine-epichlorohydrin polymer (B) in an amount of 0.5 to 7 mass % as solid content.

9. An ink jet sheet as described in claim 8, wherein the binder included in the ink receiving layer contains a biodegradable resin (C) in an amount of 50 mass % or more.

10. An ink jet sheet as described in claim 4, wherein the binder included in the ink receiving layer contains a biodegradable resin (C) in an amount of 50 mass % or more.

11. An ink jet sheet as described in claim 3, wherein the binder included in the ink receiving layer contains a biodegradable resin (C) in an amount of 50 mass % or more.

12. An ink jet sheet as described in claim 2, wherein the binder included in the ink receiving layer contains a biodegradable resin (C) in an amount of 50 mass % or more.
